(19) United States
(12) Patent Application Publication
(10) Pub. No.: US 2016/0041066 A1
(43) Pub. Date: Feb. 11, 2016

(54) METHOD FOR MONITORING TEMPERATURE OF CLUTCH ASSEMBLY

(71) Applicant: Caterpillar Inc., Peoria, IL (US)

(72) Inventors: Jaspen T. Patenaude, Princeville, IL (US); Timothy A. Lorentz, Morton, IL (US); Ethan M. Tevis, Bloomington, IL (US); Bradley J. Will, Peoria, IL (US)

(73) Assignee: Caterpillar Inc., Peoria, IL (US)

(21) Appl. No.: 14/921,057

(22) Filed: Oct. 23, 2015

(51) Int. Cl. G01M 13/02; G01K 13/00; F16D 13/58

(52) U.S. Cl. CPC G01M 13/022; F16D 13/58; G01K 13/00; F16D 2300/18

(57) ABSTRACT

A method of monitoring a temperature of a clutch assembly of a machine is disclosed. The method includes determining a set of energy input parameters pertaining to the clutch assembly by one or more sensors. The method further includes determining a power output based on the lubricating oil temperature and the speed of the engine. The method includes determining a power input based on the pressure applied on the actuator and the clutch relative speed. The method further includes determining temperature at a surface of the reaction plate of the clutch assembly based on mathematical relationship between the power input and the power output. The method includes comparing the temperature at the surface of the reaction plate of the clutch assembly with a predefined temperature range. The method further includes creating an event, when the temperature at the surface of the reaction plate is greater than the predefined temperature range.

### TECHNICAL FIELD

The present disclosure relates to a method for monitoring temperature of a clutch assembly used in a machine.

### BACKGROUND

Generally, a machine includes a clutch assembly for transferring or disconnecting power from an engine to a transmission system of the machine. The clutch assembly includes a clutch housing, an input member connected to the engine, an output member connected to the transmission system, multiple friction discs, multiple reaction plates and an actuator disposed within the clutch housing. The friction discs and the reaction plates are coupled with splines provided on the input member and the output member, respectively. During an operation of the machine, the actuator receives power from a hydraulic system of the machine to engage the reaction plates and the friction discs to transfer the power from the engine to the transmission system. Further, when the reaction plates are engaged or partially engaged with the friction discs, the clutch assembly may operate at high temperature due to frictional movement between the reaction plates and the friction discs. Over a period of time, at such high temperature, friction material may wear rapidly. Further, in a wet clutch assembly, the operator does not get any feedback indicative of the operating conditions of the clutch assembly, which may reduce the life of the clutch assembly due to overheating of the reaction plates and the friction discs.

U.S. Publication Number 2012/0261228 (hereinafter referred to as “the '228 patent application”) discloses a method for determining clutch temperature. The method provides accurate real-time clutch temperature estimate that can be used to improve shift quality and protect against failure due to clutch overheating. The '228 patent application discloses a counter which is incremented every time the clutch exceeds a threshold temperature to track cumulative high temperature conditions. The determination of clutch temperature is done by taking account of heat generation, clutch cooling by transmission oil flow from a groove when the clutch is engaged, clutch cooling by open transmission oil flow when the clutch is disengaged, oil vaporization, and heat conduction. However, the '228 patent application does not disclose about providing a warning to an operator when the clutch assembly gets overheated.

### SUMMARY OF THE DISCLOSURE

In one aspect of the present disclosure, a method of monitoring a temperature of a clutch assembly of a machine is provided. The method includes determining a set of energy input parameters pertaining to the clutch assembly by one or more sensors. The set of energy input parameters includes a lubricating oil temperature, a speed of an engine of the machine, a pressure applied on an actuator of the clutch assembly, and a clutch relative speed, the clutch relative speed being determined based on difference between a speed of a reaction plate and a speed of a friction disc of the clutch assembly. The method further includes determining a power output based on the lubricating oil temperature and the speed of the engine. The method further includes determining a power input based on the pressure applied on the actuator and the clutch relative speed. The method further includes determining a temperature at a surface of the reaction plate of the clutch assembly based on a mathematical relationship between the power input and the power output. The method further includes comparing the temperature at the surface of the reaction plate of the clutch assembly with a predefined temperature range. The method further includes creating an event, when the temperature at the surface of the reaction plate is greater than the predefined temperature range.

Other features and aspects of this disclosure will be apparent from the following description and the accompanying drawings.

### BRIEF DESCRIPTION OF THE DRAWINGS

FIG. 1 is a partial sectional view of an exemplary clutch assembly and a system associated with the clutch assembly for monitoring a temperature generated in the clutch assembly, according to the concepts of the present disclosure;

FIG. 2 is a block diagram of the system for monitoring the temperature of the clutch assembly; and

FIG. 3 is a flow chart of a method of monitoring the temperature of the clutch assembly.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

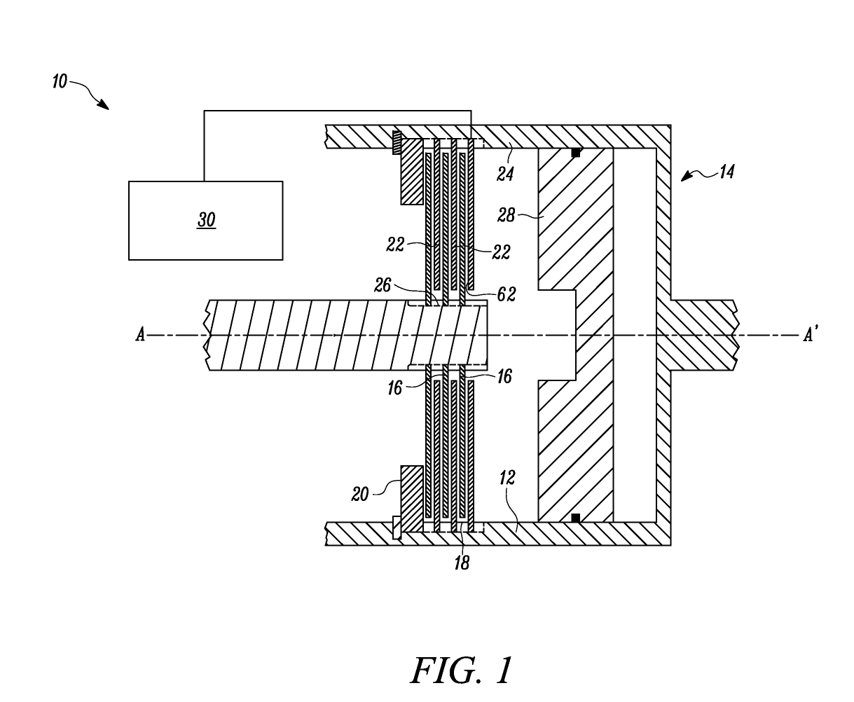

FIG. 1 shows a partial sectional view of an exemplary clutch assembly 10 used in a machine (not shown). The clutch assembly 10 is used with a transmission system of an on-highway or an off-highway vehicle. Similar clutch assemblies are known to be used in differentials and braking systems. The clutch assembly 10 is disposed between a power source, such as an engine and a transmission system of the machine. The clutch assembly 10 enables the transmission or disconnection of power from the power source to auxiliary drives or ground engaging elements, such as, wheels or tracks of the machine. The clutch assembly 10 includes an input member 12 for receiving the power from the engine. Further, the input member 12 extends along a rotational axis A-A′ defined by the clutch assembly 10. The clutch assembly 10 includes a housing member 14 coupled to the input member 12. The housing member 14 encloses various components of the clutch assembly 10. The clutch assembly 10 further includes a number of friction discs 16. The friction discs 16 are movably coupled with a spline 18 provided on the input member 12. A stopping member 20 is coupled to the input member 12 to restrict axial movement of the friction discs 16 in an engaged condition of the clutch assembly 10.

The clutch assembly 10 further includes a number of reaction plates 22 disposed on an output member 24. The reaction plates 22 are slidably engaged with splines 26 provided on the output member 24. The reaction plates 22 are disposed on the output member 24, such that the friction discs 16 and the reaction plates 22 are alternatively disposed adjacent to each other. The clutch assembly 10 further includes an actuator 28 disposed within the housing member 14. The actuator 28 moves between a first position and a second position based on actuation of hydraulic system of the machine. The hydraulic system is fluidly communicated with the clutch assembly 10. When the actuator 28 is in the first position, the reaction plates 22 are disengaged from the friction discs 16. Further, when the actuator 28 moves to the second position, the reaction plates 22 are engaged with the adjoining friction discs 16 against the stopping member 20. The clutch assembly 10 further includes a system 30 for monitoring a temperature generated in the clutch assembly 10 during operation of the machine. Heat is generated due to relative motion and friction between the friction discs 16 and reaction plates 22. The system 30 further includes a controller for receiving one or more inputs indicative of one or more operating conditions of the clutch assembly 10 and for providing a warning based on a predefined temperature range to an operator of the machine.

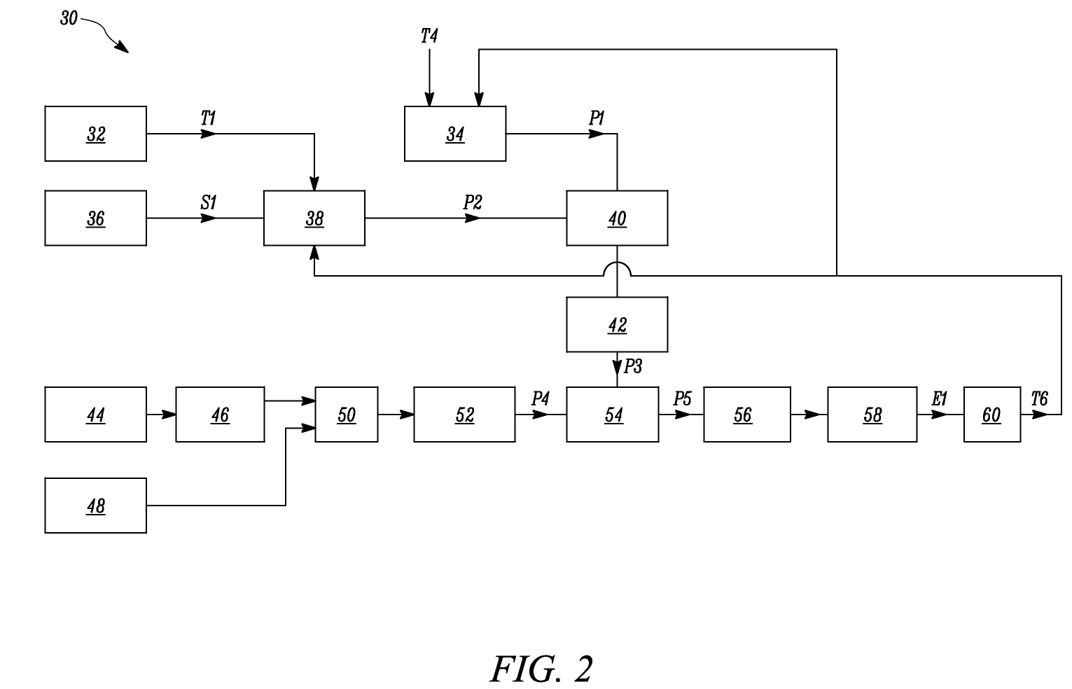

FIG. 2 shows a block diagram of the system 30 for monitoring the temperature of the clutch assembly 10. At block 32, a temperature ‘T1’ of a lubricating oil is determined. The lubricating oil is circulated to the friction discs 16 and the reaction plates 22 of the clutch assembly 10 for lubrication and for absorbing heat generated by the clutch assembly 10 during operation of the machine. In one example, the temperature ‘T1’ of the lubricating oil is determined based on a temperature of oil coolant used in the machine. More specifically, a temperature ‘T2’ upstream of the oil coolant and a temperature ‘T3’ downstream of the oil coolant are determined. Further, the temperature ‘T1’ of the lubricating oil is determined based on a difference between the temperature ‘T2’ upstream of the oil coolant and the temperature ‘T3’ downstream of the oil coolant. The temperature ‘T2’ upstream of the oil coolant and the temperature ‘T3’ downstream of the oil coolant may be determined by a temperature sensor. In another example, the temperature ‘T1’ of the lubricating oil may be determined using an oil temperature sensor.

At block 34, a conductive model is used for determining a temperature ‘T4’ of the housing member 14 of the clutch assembly 10. The heat from the lubricating oil is absorbed by the housing member 14 by means of thermal conduction. The conductive model may be a mathematical relationship known in the art. The temperature ‘T1’ of the lubricating oil is considered for determining the temperature ‘T4’ of the housing member 14 of the clutch assembly 10 using the conductive model.

At block 36, a speed ‘S1’ of the engine is determined. The system 30 includes a speed sensor located on the engine. The speed sensor generates signal indicative of the speed ‘S1’ of the engine. At block 38, a convective model is used to determine a temperature at an interface of the friction discs 16 and the reaction plates 22. The convective model may be a mathematical relationship known in the art. The speed ‘S1’ of the engine is considered as an input parameter for the convective model and is used to determine the lubricating oil mass flow rate and the temperature at the interface of the friction discs 16 and the reaction plates 22. Further, the temperature ‘T1’ of the lubricating oil is considered for determining the temperature at the interface of the friction discs 16 and the reaction plates 22 using the convective model. In an example, the convective model may also include various other operating parameters of the clutch assembly 10 for determining the temperature at the interface of the friction discs 16 and the reaction plates 22.

At block 40, a first power output ‘P1’ from the clutch assembly 10 and a second power output ‘P2’ are determined based on the conductive model and the convective model. At block 42, a power output ‘P3’ is determined based on a mathematical relationship between the first power output ‘P1’ and the second power output ‘P2’. In an example, the first power output ‘P1’ and the second power output ‘P2’ may be summed to determine the power output ‘P3’. At block 44, a pressure acting on the actuator 28 is determined based on a pressure of oil applied on the actuator 28 to move the actuator 28 to the second position form the first position. The system 30 includes one or more control valves (not shown) for controlling a flow of the oil and the pressure of the oil flowing into the housing member 14 of the clutch assembly 10. In an example, the control valves may be controlled to determine the pressure acting on the actuator 28.

At block 46, a torque applied on the clutch assembly 10 is determined based on a torque capacity model. The torque capacity model may be a mathematical relationship known in the art. In an example, a torque capacity of the clutch assembly 10 may be determined based on various operating parameters of the clutch assembly 10 including, but not limited to, a clamping force applied on the reaction plates 22 and the friction discs 16, radius of the gyration of the friction material provided on the friction discs 16, friction surfaces of the friction discs 16, and coefficient of friction of the friction material.

At block 48, a clutch relative speed is determined. The clutch relative speed corresponds to the difference between the speed of the reaction plates 22 and the speed of the friction discs 16 of the clutch assembly 10. In the second position of the actuator 28, the friction discs 16, and the reaction plates 22 engage each other such that an input speed ‘S2’ of the input member 12 and an output speed ‘S3’ output member 24 is same. However, in partial engagement of the friction discs 16 and the reaction plates 22, the friction discs 16 rotate at a speed different than a speed at which the reaction plates 22 rotate. In such a case, the output speed ‘S3’ of the output member 24 is greater than or less than the input speed ‘S2’ of the input member 12.

At block 50, an output of the torque capacity model and the clutch relative speed is multiplied to provide the power input ‘P4’ at block 52. In an example, any known mathematical relationship may be used for determining the power input ‘P4’ based on the output of the torque capacity model and the clutch relative speed. At block 54, the power input ‘P4’ to the clutch assembly 10 and the power output ‘P3’ of the clutch assembly 10 is summed to determine a final power input ‘P5’ at block 56. In an example, the final power input ‘P5’ may be determined based on a known mathematical relationship between the power input ‘P4’ and the power output ‘P3’.

At block 58, the final power input ‘P5’ is processed to determine a net energy input ‘E1’. In an example, an integral function of the final power input ‘P5’ may be calculated to determine the net energy input ‘E1’. A known mathematical relationship may be used for determining the net energy output ‘E1’ based on the final power input ‘P5’. At block 60, a plate temperature model, otherwise known as lumped capacitance model, is used to determine a temperature ‘T6’ at a surface 62 (shown in FIG. 1) of the reaction plates 22 of the clutch assembly 10. The plate temperature model may be a mathematical relationship known in the art. The net energy input ‘E2’ is considered for determining the temperature ‘T6’ at the surface 62 of the reaction plates 22 using the plate temperature model. In an example, the plate temperature model may also include various other operating parameters of the clutch assembly 10 for determining the temperature ‘T6’ at the surface 62 of the reaction plates 22. Further, the determined temperature ‘T6’ is sent as an input to the convective model to determine the temperature at an interface of the friction discs 16 and the reaction plates 22.

The system 30 is further configured to compare the temperature ‘T6’ at the surface 62 of the reaction plate with a predefined temperature range ‘T7’. If the temperature is within the predefined temperature range ‘T7’, then an event is logged in the controller. The predefined temperature range ‘T7’ is defined based on an accelerated wear that may occur in the reaction plates 22 due to the temperature generated in the clutch assembly 10 during the operation of the machine. The accelerated wear is defined based on a period of time for which the temperature at the surface 62 of the reaction plates 22 is greater than the predefined temperature range ‘T7’.

### INDUSTRIAL APPLICABILITY

The present disclosure relates to the system 30 and a method 64 of monitoring the clutch assembly 10 of the machine. The system 30 provides an indication to the operator when the temperature of the clutch assembly 10 exceeds the predefined temperature range ‘T7’. Thus, the system 30 enables the operator of the machine to receive the warning when the clutch assembly 10 is overheated. Further, the system 30 assists the operator to operate the clutch assembly 10 within the predefined temperature range ‘T7’ to reduce the wear of the clutch assembly 10 during the operation of the machine.

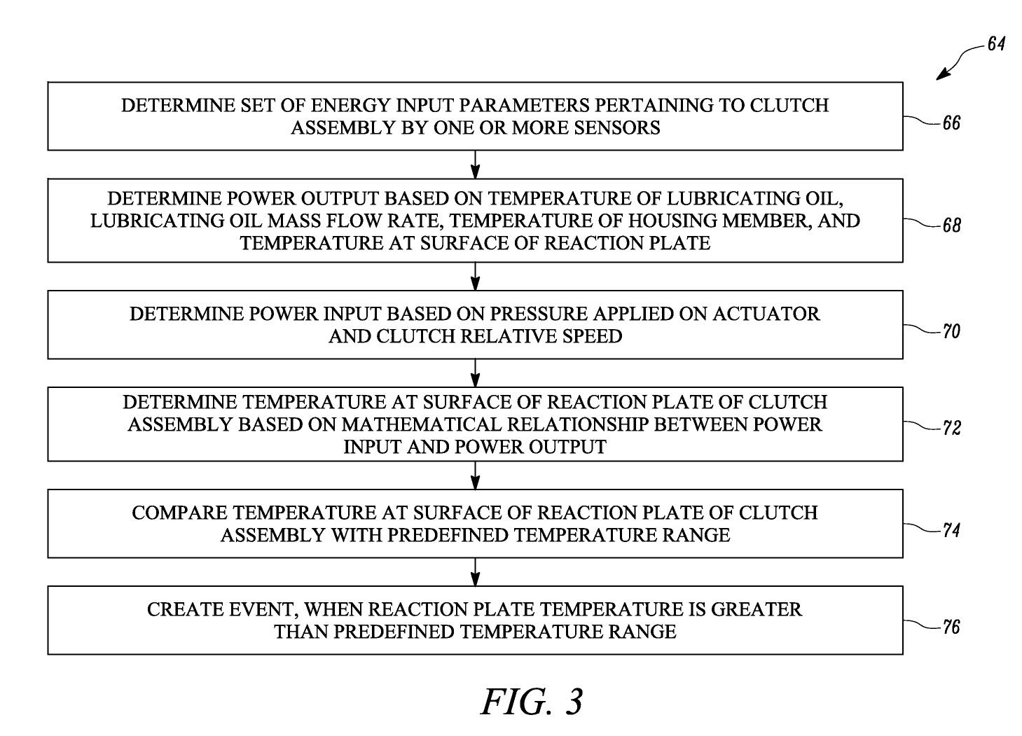

FIG. 3 shows a flowchart of the method 64 of monitoring the clutch assembly 10 of the machine. At step 66, the method 64 includes determining a set of energy input parameters pertaining to the clutch assembly 10 by one or more sensors. The set of energy input parameters includes the temperature ‘T1’ of the lubricating oil, the speed ‘S1’ of the engine, the pressure applied on the actuator 28 of the clutch assembly 10, and the clutch relative speed. The clutch relative speed is determined based on difference between the speed of the reaction plates 22 and the speed of the friction discs 16 of the clutch assembly 10. At step 68, the method 64 includes determining the power output ‘P3’ based on the temperature ‘T1’ of the lubricating oil, lubricating oil mass flow rate, the temperature ‘T4’ of the housing member, and the temperature ‘T6’ at the surface 62 of the reaction plate. At step 70, the method 64 includes determining the power input ‘P2’ based on the pressure applied on the actuator 28 and the clutch relative speed.

Further, at step 72, the method 64 includes determining the temperature ‘T6’ at the surface 62 of the reaction plates 22 of the clutch assembly 10 based on a mathematical relationship between the power input ‘P4’ and the power output ‘P3’. The net energy input ‘E1’ is considered for determining the temperature ‘T6’ at the surface 62 of the reaction plates 22 using the plate temperature model. The determined temperature ‘T6’ is sent as an input to both the convective model to determine the power output ‘P2’ at an interface of the friction discs 16 and the reaction plates 22 and the conduction model to determine the power output ‘T1’ at the interface of the reaction plate and housing member 14 of the clutch assembly 10.

At step 74, the method 64 includes comparing the temperature ‘T6’ at the surface 62 of the reaction plates 22 of the clutch assembly 10 with the predefined temperature range ‘T7’. At step 76, the method 64 includes creating an event, when the temperature ‘T6’ at the surface 62 of the reaction plates 22 is greater than the predefined temperature range ‘T7’. Further, the system 30 increases the life of the clutch assembly 10 as the operator is able to modify the operating condition of the clutch assembly 10 of the machine.

While aspects of the present disclosure have been particularly shown and described with reference to the embodiments above, it will be understood by those skilled in the art that various additional embodiments is be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of monitoring a temperature of a clutch assembly of a machine, the method comprising:
determining a set of energy input parameters pertaining to the clutch assembly by one or more sensors, the set of energy input parameters including:
a lubricating oil temperature;
a speed of an engine of the machine;
a pressure applied on an actuator of the clutch assembly; and
a clutch relative speed, the clutch relative speed being determined based on difference between a speed of a reaction plate and a speed of a friction disc of the clutch assembly;
determining a power output based on the lubricating oil temperature and the speed of the engine;
determining a power input based on the pressure applied on the actuator and the clutch relative speed;
determining a temperature at a surface of the reaction plate of the clutch assembly based on a mathematical relationship between the power input and the power output;
comparing the temperature at the surface of the reaction plate of the clutch assembly with a predefined temperature range; and
creating an event, when the temperature at the surface of the reaction plate is greater than the predefined temperature range.
